(19) United States
(12) Patent Application Publication
(10) Pub. No.: US 2013/0167793 A1
(43) Pub. Date: Jul. 4, 2013

(54) METHOD TO BALANCE MASS MOMENTS OF A DRIVE UNIT AND DRIVE UNIT FOR PERFORMANCE OF SUCH A METHOD

(71) Applicant: Ford Global Technologies, LLC, Dearborn, MI (US)

(72) Inventor: Michael Roehrig, Koeln (DE)

(73) Assignee: FORD GLOBAL TECHNOLOGIES, LLC, Dearborn, MI (US)

(21) Appl. No.: 13/733,764

(22) Filed: Jan. 3, 2013

(30) Foreign Application Priority Data
Jan. 3, 2012 (DE) 102012200028.3

(51) Int. Cl. F02B 75/06

(52) U.S. Cl. CPC F02B 75/065
USPC 123/192.2

(57) ABSTRACT

A method to balance a crank drive of an internal combustion engine comprising: using a balancer unit comprising a first balance weight and a second balance weight serving as counterbalance; rotating the first and second balance weight at an engine rotation speed when a crankshaft rotates at the engine rotation speed; rotating the first balance weight in a same direction as the crankshaft; rotating the second balance weight in an opposite direction to the crankshaft; arranging the first balance weight and the second balance weight such that a resulting balancing moment about a velocity pole of a 1st order of a rigid body rotation of a drive unit at least partially balances a rotary movement about a velocity pole provoked by a resulting mass moment of the 1st order, an external effect of the resulting mass moment of the 1st order being at least partially balanced.

### CROSS REFERENCE TO RELATED APPLICATIONS

The present application claims priority to German Application 102012200028.3, filed on Jan. 3, 2012, the entire contents of which are hereby incorporated by reference for all purposes.

### TECHNICAL FIELD

The disclosure relates to a crank drive of an internal combustion engine and a method to balance mass moments thereof.

### BACKGROUND AND SUMMARY

The disclosure concerns a method to balance the mass moments provoked by the mass forces of the 1st order of a crank drive of an internal combustion engine. The crank drive belongs to a drive unit with at least one cylinder, wherein the crank drive comprises a crankshaft and at least one piston pivoted on this crankshaft. The piston belongs to the at least one cylinder. The crank drive of the present disclosure uses a balancer unit comprising two balance weights which rotate with the engine rotation speed when the crankshaft rotates with engine rotation speed. The effect of the resulting mass moment of the rotating balance weights at least partially balances the crankshaft.

Furthermore the disclosure concerns a drive unit for performance of such a method.

Drive units of said type are frequently used as vehicle drives and usually comprise a gearbox as well as an internal combustion engine. As part of the present disclosure, the drive unit can also be a hybrid drive which additionally comprises an electric drive or fuel cell. In all cases the drive unit according to the disclosure forms a cohesive assembly.

In the design and layout of motor vehicles and internal combustion engines, increasing attention is being paid to vibrations. Attempts are made to influence and model the noise caused by the internal combustion engine in a targeted manner. Measures in this context are usually combined under the term “noise design” or “sound design”. Such development work is also motivated by the knowledge that a customer's vehicle purchase decision is influenced not inconsiderably—and to an increasing extent even decisively—by the noise of the internal combustion engine or vehicle. Thus, the driver of a sports car prefers a vehicle or engine, the sound of which emphasizes the sporting character of the vehicle.

As part of noise design or sound design, vibrations are balanced, e.g. eliminated or compensated for. In some cases, individual vibrations of a specific frequency are isolated, filtered out or, where applicable, modeled.

The noise sources in a motor vehicle can be divided into:
flow noise,
noise from body-borne sound emission, and
noise from body-borne sound introduced into the bodywork via the engine mounts.

Flow noise includes, for example, the exhaust tailpipe noise, the intake noise and the sound of the fan. Whereas noises from body-borne sound emission include the actual engine noise and the noise emissions from the exhaust system. The engine structure, excited to vibrate by pulses and alternating forces, emits body-borne sound via its engine surfaces as air-borne sound, and in this way generates the actual engine noise.

Body-borne sound introduced via the engine mounts, in particular body-borne sound introduced into the vehicle bodywork, is particularly important for acoustic driving comfort.

The drive unit or internal combustion engine and associated ancillaries are vibratable systems, the vibrational behavior of which can be influenced. The most relevant components with respect to pulse and force excitation are the crankcase, cylinder block, cylinder head, crank drive, piston and valve drive. These components are exposed to mass and gas forces. The crank drive here comprises in particular the crankshaft, piston, piston bolt and connecting rod, and forms the vibratable system relevant for the method according to the disclosure.

The crankshaft is excited to rotary vibration by the temporally changing rotary forces which are introduced into the crankshaft via the connecting rods pivoted on the individual crank journals. These rotary vibrations lead to noises both from body-borne sound emission and from body-borne sound introduced into the bodywork and into the internal combustion engine, wherein vibrations can also occur which negatively affect driving comfort, for example, vibrations of the steering wheel in the passenger compartment. When the crankshaft is excited in its inherent frequency range, high rotary vibration amplitudes can occur which can even lead to fatigue rupture. This shows that the vibrations are relevant, not only, in connection with noise design but also with regard to component strength.

The rotary vibrations of the crankshaft are transmitted undesirably to the camshaft via the timing gears or camshaft drive, wherein the camshaft itself also constitutes a vibratable system and can excite other systems, in particular the valve drive, to vibrate. The introduction of vibrations into other ancillaries via traction mechanism drives driven by the crankshaft is also possible. Also, vibrations of the crankshaft are introduced into the drive train, via which they can be transmitted further as far as the vehicle tires.

The rotary force development at a crankshaft throw of a four-stroke internal combustion engine is periodic, wherein the periods extend over two revolutions of the crankshaft. Usually the rotary force development is broken down into its harmonic components by means of Fourier analysis in order to draw conclusions on the excitation of rotary vibrations. Here the actual rotary force development is composed of a constant rotation force and a multiplicity of harmonically changing rotation forces with different rotation force amplitudes and frequencies or vibration counts. The ratio of the vibration count nᵢ of each harmonic to the rotation speed n of the crankshaft or engine is known as the order i of the harmonic.

Because of the high dynamic load on the crankshaft from the mass and gas forces, the aim in the design of the internal combustion engine is to achieve a mass balance which is as extensive as possible, e.g. optimized. The term “mass balance” here includes all measures which compensate for, or reduce, the external effect of the mass forces. To this extent, a method for mass balance also includes measures to balance the moments provoked by the mass forces.

A mass balance can, in individual cases, be achieved simply by targeted matching of the crankshaft throw, the number and arrangement of the cylinders, and the ignition sequence.

A six-cylinder in-line engine can be fully balanced in this way. The six cylinders are paired such that they run mechanically in parallel as cylinder pairs. Thus the first and the sixth cylinders, the second and the fifth cylinders, and the third and fourth cylinders are paired into cylinder pairs, wherein the crankshaft journals or throws of the three cylinder pairs are arranged on the crankshaft each offset by 120° CA. Running mechanically parallel means that both pistons of the two mechanically parallel running cylinders are at top dead center (TDC) or bottom dead center (BDC) at the same ° CA (crank angle degree). When a suitable ignition sequence is selected, the mass forces are fully balanced.

In a three-cylinder in-line engine, the mass forces of the 1st order and the mass forces of the 2nd order can also be fully balanced by selection of a suitable crankshaft throw and suitable ignition sequence, but not the moments provoked by the mass forces.

A full mass balance cannot always be achieved, so further measures must be taken. For example, the arrangement of counterweights on the crankshaft and/or providing of at least one balancer unit in the internal combustion engine may aid in balancing the masses.

The starting point of all measures is the consideration that the crankshaft is loaded by the temporally changing rotary forces comprising gas forces and mass forces of the crank drive. The masses of the crank drive, e.g. the individual masses of the connecting rod, piston, piston bolt and piston rings, can be transferred into an oscillating substitute mass and a rotating substitute mass. The mass force of the rotating substitute mass can easily be balanced in its external effect by counterweights arranged on the crankshaft.

Balancing the rotating mass force provoked by the oscillating substitute mass is more complex since this force is approximately composed of a mass force of the 1st order which rotates with the engine rotation speed and a mass force of the 2nd order which rotates at twice the engine rotation speed, wherein forces of higher order are negligible.

The rotating mass forces of each order can almost be balanced by the arrangement of two shafts fitted with corresponding weights and rotating in opposite directions, known as balancer shafts. The shafts to balance the mass forces of the 1st order rotate with the engine rotation speed and the shafts to balance the mass forces of the 2nd order rotate at twice the engine rotation speed. This method of mass balancing is very cost intensive and complex and, in addition to the high weight associated with the two sets of mass forces, requires considerable space.

Also, on full balancing of the rotating mass forces, mass moments are produced as the mass forces of the individual cylinders act in the cylinder center planes. These mass moments can, in individual cases, be balanced by a balancer shaft fitted with weights. A balancer shaft increases the space requirements, costs and weight of the entire mass balance system and hence the drive unit.

The moments provoked by the mass forces of the 1st order for example in a three-cylinder in-line engine can be balanced by a single balancer shaft rotating with the engine rotation speed in the opposite direction to the crankshaft, on the ends of which are arranged two balance weights offset by 180°, e.g. twisted, and serving as counterbalance.

The provision of one or, where applicable, more balancer shafts not only increases the space requirements and the costs but also the fuel consumption. The increased fuel consumption is caused firstly by the additional weight of the balancer unit, in particular the shafts and the counterweights serving as counterbalance which increase the total weight of the drive unit. Secondly, the balancer unit with its rotating shafts and other moving components contributes to the friction load on the internal combustion engine. The latter is particularly relevant since the balancer unit is always and continuously in operation as soon as the internal combustion engine is started and operated. The balancing of mass forces is therefore permanently in operation, irrespective of whether the momentary operating state of the internal combustion engine requires such a mass balancing.

Known methods, in which balancing the mass moments of the 1st order, utilize two balance weights twisted by 180° arranged on a balancer shaft. The two balance weights serve as counterbalance and rotate with the engine rotation speed in the opposite direction to the crankshaft. The substantial difference of the method according to the disclosure lies in that, according to the disclosure, the two balance weights serving as counterbalance rotate in opposite directions to each other. Here the first balance weight rotates in the same direction as the crankshaft while the second balance weight rotates in the opposite direction to the crankshaft.

Consequently the two balance weights cannot be arranged on the same carrier, for example a shaft. Rather the two balance weights require different carriers which transfer the rotation movement to them in different directions. The carrier for the first balance weight can for example be an arbitrary rotation body arranged on the crankshaft. The second balance weight requires a carrier rotating in the opposite direction to the crankshaft which can also be driven by the crankshaft itself. In both cases an existing component can be used as a carrier. An existing component in the context of the present disclosure is any component which already—as well as supporting a balance weight—fulfills at least one further function, e.g. task related to the operation of the internal combustion engine.

The statements above show that there is a need for an improved method of mass balancing, wherein low space requirement, low cost, low weight and low friction are desired.

In this context it is an object of the present disclosure to indicate a method to balance the mass moments provoked by the mass forces of the 1st order which allows a mass balancing which is characterized by low space requirement, low cost, low weight and low friction.

A further task of the present disclosure is to provide a drive unit for performance of such a method.

The present disclosure provides a method to balance the mass moments provoked by the mass forces of the 1st order of a crank drive of an internal combustion engine. The crank drive belongs to a drive unit with at least one cylinder. The crank drive comprises a crankshaft and at least one piston, belonging to the at least one cylinder, pivots on this crankshaft. This is achieved using a balancer unit comprising two balance weights serving as counterbalance which rotates with the engine rotation speed when the crankshaft rotates with the engine rotation speed. The external effect of the resulting mass moment of the 1st order is at least partial balance. The method is characterized in that the two balance weights serving as counterbalance rotate in opposite directions to each other, wherein
a first balance weight rotates in the same direction as the crankshaft and a second balance weight rotates in the opposite direction to the crankshaft, and
the balance weights serving as counterbalance are arranged and dimensioned such that the resulting balancing moment about the velocity pole of the 1st order of the rigid body rotation of the drive unit at least partially balances the rotary movement about the velocity pole provoked by the resulting mass moment of the 1st order, an external effect of the resulting mass moment of the 1st order being at least partially balanced.

A feature of the present disclosure is that no additional component is required as a carrier for a balance weight. The balancer shafts known from the prior art which are usually driven on the crankshaft side via a belt drive or a gear pair and/or are usually arranged below the crankcase are not required because of the principle of the different rotation directions of the two balance weights. The omission of the shaft saves space and leads to a weight reduction, a reduction in friction and hence a reduction in fuel consumption.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a three cylinder in line engine.

FIG. 2 shows a schematic diagram of a single cylinder of a drive unit.

FIG. 3 shows a crank drive in accordance with an embodiment of the present disclosure. The crankshaft and mass positioning is shown to scale, although other relative dimensions may be used.

FIG. 4 diagrams a method of the present disclosure.

### DETAILED DESCRIPTION

In contrast to the prior art in which the force pair comprising the mass forces of the two balance weights rotating in the same direction increases in the sum, and the resulting moment is a so-called free moment which is and remains equally large in relation to an arbitrary reference point, the method according to the disclosure is characterized in that as a result of the balance weights rotating in opposite directions, a free resulting force remains and a bonded moment, which is dimensioned such that the rotary movement provoked by the resulting mass moment of the 1st order about the velocity pole of the 1st order of the rigid body rotation of the drive unit is balanced.

The present disclosure provides a system and method to at least partially balance a crank drive that requires less space and is lighter weight than existing systems. The method employs two balance weights that can be arranged on crank drive components. The two balance weights rotate at the engine rotation speed. The two balance weights rotate in opposing directions and they act to counter balance vibrations of the crank drive.

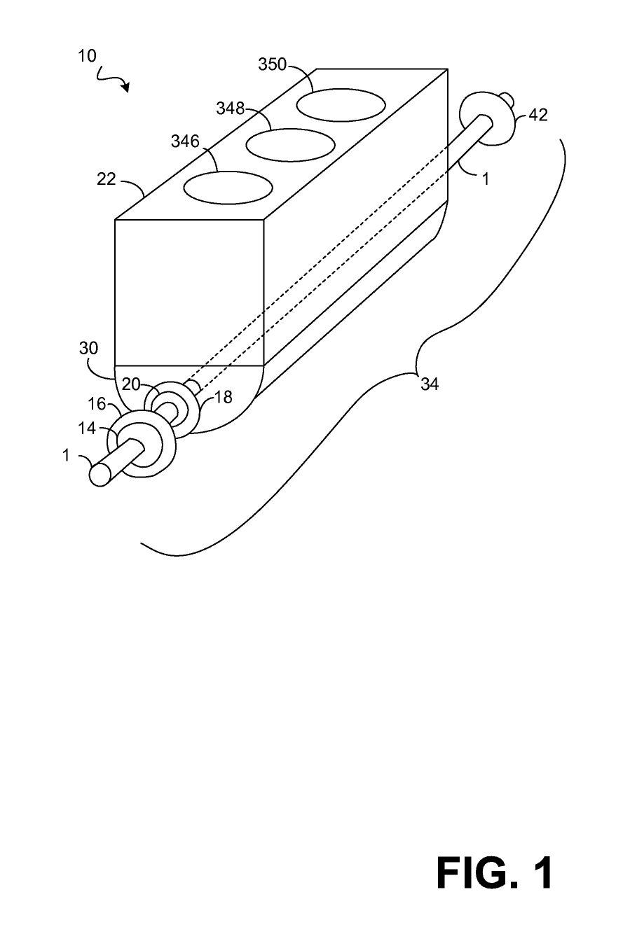

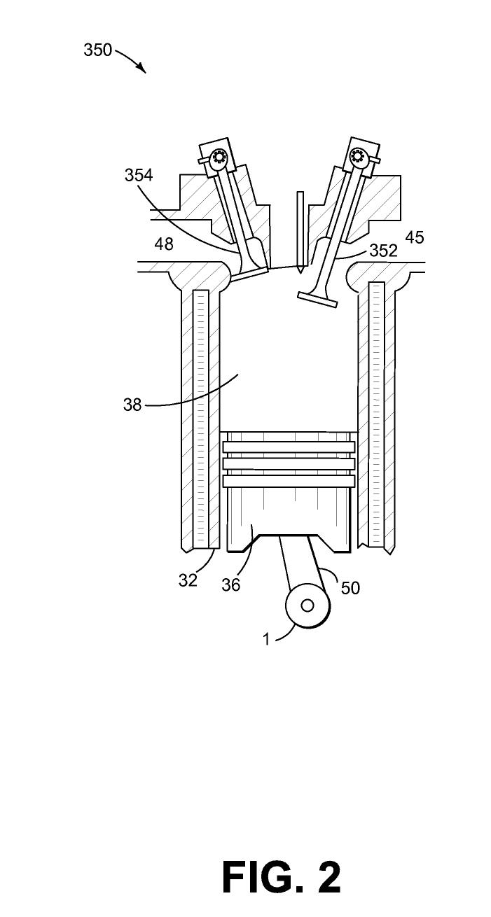

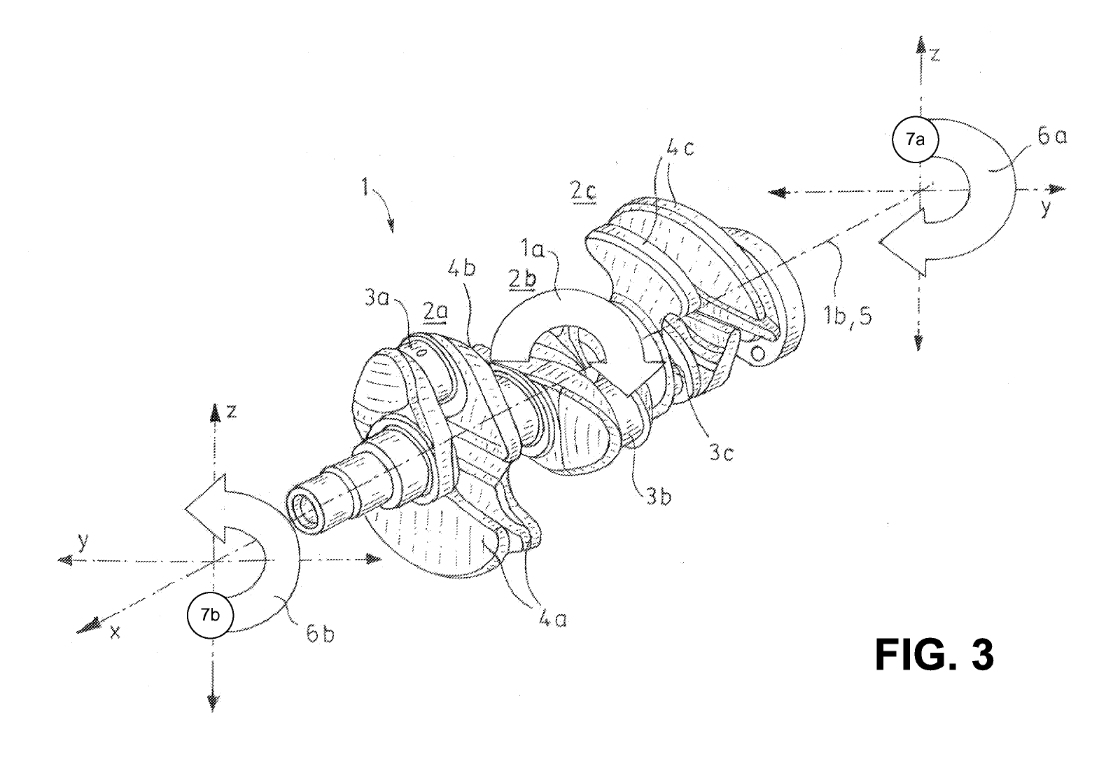

Referring now to the figures, an example drive unit in accordance with the present disclosure is shown in FIG. 1. A three cylinder in line engine is shown generally at 10. Engine block 22 contains three cylinders 346, 348 and 350, an example of which is shown in greater detail below in FIG. 2. Below engine block 22 crankcase 30 houses crankshaft 1. The crankshaft is further detailed below in FIGS. 2 and 3. Here crankshaft 1 is shown as the center of rotation of a crank drive depicted generally at 34.

In this example crank drive 34 contains a flywheel 42, gear wheel 16 and second gear wheel 14, and traction mechanism drive 18 with a wheel 20 outside the traction mechanism drive 18. The traction mechanism drives a wheel arranged on the outside of the traction mechanism. In one embodiment the second balance weight is provided on this wheel rotating in the opposite direction to the crankshaft. In another embodiment, a gear wheel which is arranged on the crankshaft and is in engagement with a second gear wheel, wherein the second balance weight is provided on the second gear wheel and rotates in the opposite direction to the crankshaft. In a third embodiment, a flywheel is arranged on the crankshaft, wherein the first balance weight is provided on the flywheel.

Several examples of existing components of the drive unit on which the balancing weights may be arranged are provided. However, these examples need not be limiting and there may be additional elements on a crank drive that could be used to carry the balancing weights. Furthermore, the balancing weights may be their own separate components and not be arranged on or in connection to another component of the drive unit or crank drive. Additionally, the linear arrangement of components on the crankshaft may vary.

It should be understood that the balancing unit of the present disclosure could be configured to balance the crank drive of many engine types including inline, v-engines, and flat engines with one of more cylinders. Furthermore, the crank drive may contain additional elements not shown here. Additionally, elements depicted on crank drive 34 may not be present in all engines that could be configured with a balance unit of the present disclosure.

Referring now to FIG. 2 an example cylinder is depicted at 350. Cylinder 350 may be one of the cylinders of an inline three cylinder engine, as shown in FIG. 1, or may be part of an engine of different configuration or cylinder number. Basic components of cylinder 350 include the combustion chamber 38. Combustion chamber 38 is where a fuel air mixture is allowed into the chamber by intake valve 354 via intake port 48. Combustion of the air-fuel mixture in combustion chamber 38 forces piston 36 down along cylinder walls 32. Linear movement of piston 36 is translated to rotary motion of crankshaft 1 via connecting rod 50 acting on a crank arm. Combustion products leave combustion chamber 38 through exhaust port 45 when exhaust valve 352 is open. For the system and method of the present disclosure, the internal combustion engine may be a compression ignition or spark ignition and can combust gasoline, ethanol, diesel or other fuel.

FIG. 3 shows the crankshaft 1 of a first embodiment of the drive unit in a perspective view. This is the crankshaft 1 of a three-cylinder in-line engine which comprises three cylinder crank assemblies 2a, 2b, and 2c arranged in line along the longitudinal axis 1b of the crankshaft 1. The crankshaft pins 3a, 3b, and 3c of the three cylinder crank assemblies 2a, 2b, and 2c are formed offset to each other by 120° about the longitudinal axis 1b so that the rotating mass forces of the 1st order and 2nd order of the oscillating substitute masses are balanced with corresponding ignition timing.

The mass forces of the rotating substitute masses are balanced in their external effect by the counterweights 4a, 4b, and 4c arranged on the crankshaft 1. Here, in the region of each crankshaft pin 3a, 3b, and 3c are arranged two counterweights 4a, 4b, and 4c, namely on the side of the crankshaft 1 opposite the crankshaft pin 3a, 3b, and 3c.

To balance the mass moments provoked by the mass forces of the 1st order, two balance weights 7a and 7b are provided, serving as counterbalance, which also rotate with the engine rotation speed in the directions of arrows 6a and 6b when the crankshaft 1 rotates with the engine rotation speed in the direction of arrow 1a. The longitudinal axis 1b of the crankshaft 1 forms the common rotary axis 5.

The two balance weights 7a and 7b, serving as counterbalance, rotate in opposite directions to each other, indicated by the arrows 6a and 6b representing the direction of rotation of the balance weights.

With a crankshaft 1 rotating according to the arrow 1a, the first balance weight 7a rotates in the same direction as the crankshaft 1, e.g. according to the arrow 6a, and the second balance weight 7b rotates in the opposite direction to the crankshaft 1, e.g. according to the arrow 6b.

The distance of the balance weights serving as counterbalance from the velocity pole of the 1st order should advantageously be selected as large as possible in order to be able to generate the balancing moment with as little mass as possible. It must be taken into account that also the masses of the balance weights according to the disclosure are included in the total weight of the drive unit.

The resulting moment of the two rotating balance weights about the velocity pole of the 1st order of the rigid body rotation of the drive unit balances the rotary movement about the velocity pole provoked by the resulting mass moment of the 1st order, so that the external effect of the resulting mass moment of the 1st order is balanced.

The fact that a free resulting force remains as a consequence of the balance weights rotating in opposite directions leads to no significant disadvantages, as tests, in particular measurements of acceleration in the bearings of the crankshaft, have shown. Rather there is also a possibility of modeling the free resulting force advantageously, in particular in size and direction.

The two balance weights are dimensioned and arranged such that the resulting mass force becomes a mass force oscillating in the longitudinal direction of the motor vehicle, e.g. for an engine installed transversely in the x-direction, a mass force oscillating in the y-direction, which at no time has components in the x-direction or z-direction.

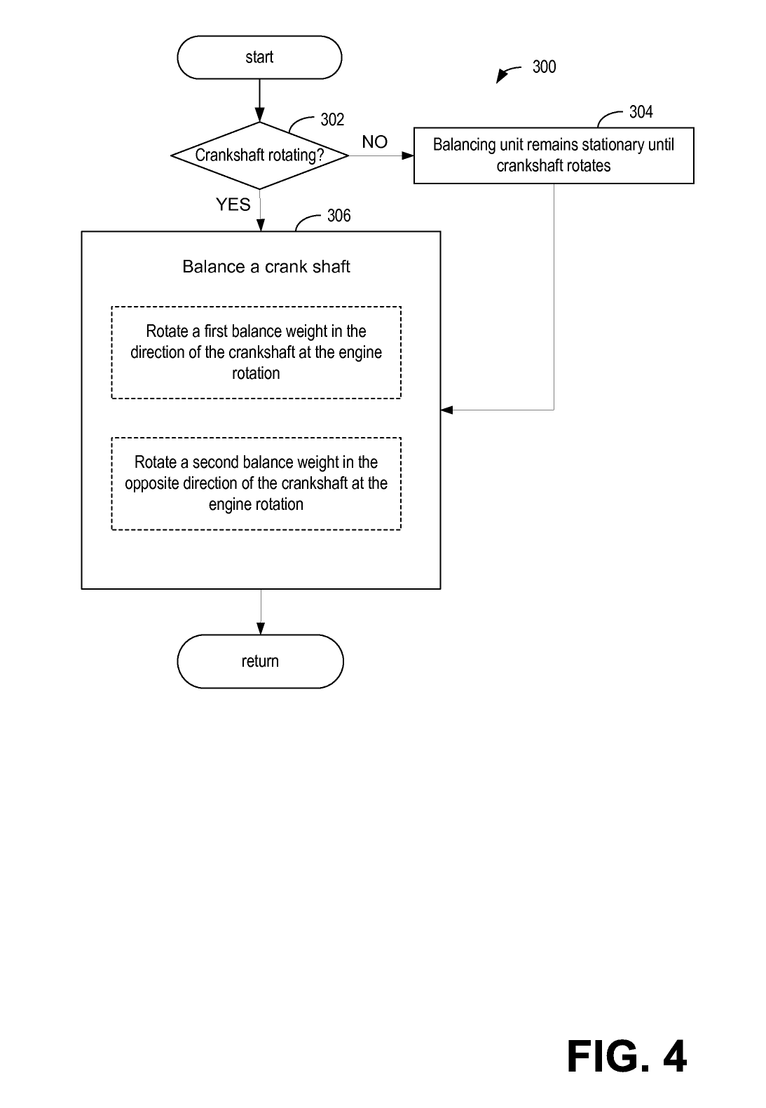

A flow chart of the method of the present disclosure is depicted in FIG. 4. The method 300 starts by determining if the crankshaft is rotating at 302. If the crankshaft is not rotating (NO at 302) the method proceeds to 304 where the balancing unit, comprising a first balance weight and a second balance weight, remains stationary until the crankshaft rotates at which point the method proceeds to 306. If the answer at 302 is YES, or when at 304, the crankshaft begins rotating the method proceeds to 306. At 306, the crank shaft is balanced, or at least partially balanced. Balancing the crank shaft comprises rotating a first balance weight in the same direction as the rotation of the crankshaft and rotating a second balance weight in a direction opposite the rotation of the crankshaft. The method then returns.

With the method according to the disclosure therefore the first object of the disclosure is achieved, namely to indicate a method to balance the mass moments provoked by the mass forces of the 1st order, allowing a mass balancing which is characterized by low space requirement, low cost, low weight and low friction.

Embodiments of the method are advantageous in which the balance weights serving as counterbalance are arranged and dimensioned such that the resulting balancing moment about the velocity pole of the 1st order of the rigid body rotation of the drive unit balances as fully as possible the rotary movement about the velocity pole provoked by the resulting mass moment of the 1st order, an external effect of the resulting mass moment of the 1st order being at least partially balanced.

This method variant is characterized by a full or as full as possible a balancing of the rotary movement which is provoked by the resulting mass moment of the 1st order. For this, larger forces (e.g. balance weights of greater mass) are required than for an at least partial balancing, so that the free resulting force is also larger, as is the effect provoked by this force.

To this extent the scope of the mass balancing must be weighed against the associated resulting force.

Embodiments of the method are advantageous in which the two balance weights rotate about the same rotary axis.

Embodiments of the method are advantageous in which at least one balance weight rotates about the longitudinal axis of the crankshaft. It is advantageous in this variant that a balance weight which rotates about the crankshaft and the mass force of which thus intersects with the longitudinal axis of the crankshaft does not provoke any moment about the crankshaft. As a carrier for the at least one balance weight, a flywheel arranged on the crankshaft can be used or another rotation body connected with the crankshaft, for example a gear wheel or a disk.

Embodiments of the method are also advantageous in which at least one balance weight rotates about a rotary axis which runs parallel to the longitudinal axis of the crankshaft. Drive units of internal combustion engines are frequently fitted with traction mechanism drives which comprise wheels and/or disks which rotate about a rotary axis that runs parallel to the longitudinal axis of the crankshaft. The present embodiment comprises method variants in which a balance weight is arranged on one of these wheels or disks.

Embodiments of the method are advantageous in which the two balance weights are dimensioned and arranged such that the resulting balancing mass force becomes an oscillating mass force. For this the two mass forces provoked by the balance weights must be equal in size.

As already stated, there is a possibility of modeling the free resulting force advantageously, e.g. designing this in a targeted manner. It is particularly advantageous to structure the resulting force as an oscillating force, preferably oscillating in the longitudinal direction of the vehicle which uses the drive unit concerned. A vehicle is usually less sensitive (e.g. more stable) to a pitching movement provoked by a force oscillating in the longitudinal direction. A vertically oscillating force, however, can lead to a skipping movement of the vehicle, and a transversely oscillating force can lead to a rolling of the vehicle. Both are considered more critical than a pitching movement.

Embodiments of the method are advantageous in which approximately the center of gravity of the drive unit is used as a velocity pole of the 1st order.

Embodiments of the method are advantageous in which an existing component of the drive unit is used as a carrier for at least one balance weight.

As already stated, this procedure reduces the number of components, whereby a compact construction is guaranteed with both low production costs and reduced fuel consumption.

The statements already made in relation to the method according to the disclosure also apply to the drive unit according to the disclosure.

In drive units with a flywheel arranged on the crankshaft, embodiments are advantageous in which the first balance weight is provided on the flywheel.

The first balance weight runs in the same direction as the crankshaft and therefore requires a carrier which also rotates in the same direction as the crankshaft, for example the flywheel. Use of the flywheel as a carrier has several advantages.

Firstly the flywheel is a component already present which primarily has another function in the operation of the internal combustion engine, namely to reduce the rotation speed fluctuations of the crank drive by the additional flywheel mass so that the rotary motion of the crankshaft is more even. Consequently all effects occur which are connected with the use of an existing component as a carrier for a balance weight, namely a reduction in the space requirement, weight, friction and hence fuel consumption.

Secondly the flywheel is usually arranged on one of the two free ends of the crankshaft so that the flywheel has a comparatively large distance from the velocity pole and consequently the first balance weight serving as counterbalance has a correspondingly large lever. As a lever increases, the mass of the balance weight needed to generate the necessary moment diminishes, wherein in principle the desire or aim is to have as light a balance weight as possible.

In drive units with a traction mechanism drive which comprises a wheel driven by the crankshaft and rotating in the opposite direction to the crankshaft, embodiments are advantageous in which the second balance weight is provided on this wheel rotating in the opposite direction to the crankshaft.

Part of the power obtained in the internal combustion engine by chemical conversion of the fuel is used to drive the ancillary assemblies necessary for operation of the internal combustion engine and motor vehicle, in particular the oil pump, coolant pump, alternator and similar.

To drive the ancillary assemblies, usually a traction mechanism drive is used, wherein belts and chains are used as traction mechanisms. Frequently the drive of several ancillary assemblies is combined in one belt or chain drive. Chains, like profiled belts and in contrast to smooth traction means, have the advantage that a slip-free drive can be guaranteed. This is also required because the rotating balance weights must have a fixed phase in relation to the rotating crankshaft, e.g. their rotation movement must be synchronized with the rotating crankshaft.

The crankshaft drives a wheel of the traction mechanism drive either directly so that the wheel—arranged for example directly on the crankshaft—rotates in the same direction as the crankshaft, or via a gear so that the wheel rotates in the opposite direction to the crankshaft. A wheel of the latter type can according to the present embodiment be used as a carrier for the second balance weight.

Like the flywheel already discussed, the traction mechanism drive is usually arranged on one of the two free ends of the crankshaft, namely on the end which is opposite the flywheel, whereby also the second balance weight serving as an counterbalance has a correspondingly large lever in relation to the velocity pole. The advantages are those already described in connection with the flywheel.

However also—or additionally—a traction mechanism drive can be formed with a wheel which is arranged not on one of the two ends of the crankshaft but spaced from the ends on the crankshaft. Such a traction mechanism drive is used according to the prior art for example to drive the camshaft (e.g. the valve drive), wherein preferably a gear wheel forms the wheel arranged on the crankshaft.

The two embodiments below relate to such a traction mechanism drive.

In drive units with the wheel which is arranged on the crankshaft and drives an assembly via a traction mechanism, embodiments are advantageous in which the traction mechanism also serves to drive a wheel rotating in the opposite direction to the crankshaft and the second balance weight is provided on this wheel rotating in the opposite direction to the crankshaft.

The assembly can be an ancillary assembly in the actual sense or for example also a valve drive as described above.

Embodiments are advantageous here in which the traction mechanism drives a wheel arranged on the outside of the traction mechanism and the second balance weight is provided on this wheel rotating in the opposite direction to the crankshaft.

A special case of a wheel arranged on the crankshaft is a gear wheel. In drive units with a gear wheel which is arranged on the crankshaft and in engagement with another gear wheel, embodiments are advantageous in which the second balance weight is provided on the other gear wheel rotating in the opposite direction to the crankshaft.

Embodiments of the drive unit can be advantageous in which a tension roller of a fraction mechanism drive serves to hold one of the two balance weights.

In order to keep the traction mechanism of a traction mechanism drive under tension and thus guarantee as safe and wear-free a drive as possible, advantageously at suitable points of the drive a tensioner device is provided which guides the traction mechanism by means of a tension roller and applies a force transverse to the traction direction, so that the traction mechanism is constantly under tension and is kept under tension.

Embodiments of the drive unit are advantageous in which the internal combustion engine comprises three cylinders arranged in line. As already described in detail, in a three-cylinder in-line engine the mass forces of the 1st order and 2nd order can be balanced by the crankshaft throw and a suitable ignition sequence, but not the moments provoked by the mass forces.

To this extent in a three-cylinder in-line engine there is a need to balance the mass moments of the 1st order, e.g. for the method according to the disclosure for mass balancing.

The balancer unit usually provided for this, with a balancer shaft which rotates in the opposite direction to the crankshaft and on which are arranged two balance weights offset by 180° to each other, is not required or is replaced by the two balance weights rotating in opposite directions to each other according to the disclosure.

In drive units used in a vehicle, embodiments are advantageous in which the two balance weights are dimensioned and arranged such that the resulting balancing mass force is a mass force oscillating in the vehicle longitudinal direction. Reference is made to the statements already made with regard to the structure of the resulting balancing mass force as an oscillating mass force. The present disclosure provides a drive unit for performance of a method to balance the oscillations of a crank drive. This balancing is achieved by a drive unit with an internal combustion engine belonging to the drive unit with:
At least one cylinder.
A crank drive comprising a crankshaft and at least one piston of the at least one cylinder pivoted on this crankshaft.
A balancer unit to balance the mass moments provoked by the mass forces of the 1st order, the balancer unit comprising two balance weights serving as counterbalance. The balance weights rotate with the engine rotation speed when the crankshaft rotates.
The two balance weights serve as counterbalance. The balance weights rotate in opposite directions to each other. The first balance weight rotates in the same direction as the crankshaft and the second balance weight rotates in the opposite direction to the crankshaft.
The balance weights serving as counterbalance are arranged and dimensioned such that the resulting balancing moment about the velocity pole of the 1st order of the rigid body rotation of the drive unit at least partially balances the rotary movement about the velocity pole provoked by the resulting mass moment of the 1st order.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method to balance a crank drive of an internal combustion engine comprising:
using a balancer unit comprising a first balance weight and a second balance weight serving as counterbalance;
rotating the first and second balance weight at an engine rotation speed when a crankshaft rotates at the engine rotation speed;
rotating the first balance weight in a same direction as the crankshaft;
rotating the second balance weight in an opposite direction to the crankshaft; and
arranging the first balance weight and the second balance weight such that a resulting balancing moment about a velocity pole of a 1st order of a rigid body rotation of a drive unit at least partially balances a rotary movement about a velocity pole provoked by a resulting mass moment of the 1st order, an external effect of the resulting mass moment of the 1st order being at least partially balanced.

2. The method as claimed in claim 1, wherein the first and second balance weights serving as counterbalance are arranged and dimensioned such that the resulting balancing moment about the velocity pole of the 1st order of the rigid body rotation of the drive unit balances the rotary movement about the velocity pole provoked by the resulting mass moment of the 1st order, an external effect of the resulting mass moment of the 1st order being at least partially balanced.

3. The method as claimed in claim 1, wherein the first and second balance weights rotate about a same rotary axis.

4. The method as claimed in claim 1, wherein at least one of the first and second balance weights rotates about a longitudinal axis of the crankshaft.

5. The method as claimed in claim 1, wherein at least one of the first and second balance weights rotates about a rotary axis which runs parallel to the longitudinal axis of the crankshaft.

6. The method as claimed in claim 1, wherein the first and second balance weights are dimensioned and arranged such that a resulting balancing mass force becomes an oscillating mass force.

7. The method as claimed in claim 1, wherein a center of gravity of the drive unit is used as the velocity pole of the 1st order.

8. The method as claimed in claim 1, wherein an existing component of the drive unit is used as a carrier for at least one balance weight.

9. A drive unit of an internal combustion engine comprising:
at least one cylinder;
a crank drive comprising a crankshaft;
at least one piston of the at least one cylinder pivoted on the crankshaft; and
a balancer unit to balance mass moments provoked by mass forces of a 1st order, comprising two balance weights serving as counterbalance which rotate with an engine rotation speed when the crankshaft rotates, wherein, the two balance weights serving as counterbalance rotate in opposite directions to each other, wherein a first balance weight rotates in a same direction as the crankshaft and a second balance weight rotates in an opposite direction to the crankshaft, and the two balance weights serving as counterbalance are arranged and dimensioned such that a resulting balancing moment about a velocity pole of a 1st order of a rigid body rotation of the drive unit at least partially balances a rotary movement about the velocity pole provoked by the resulting mass moment of the 1st order.

10. The drive unit as claimed in claim 9, further comprising a flywheel arranged on the crankshaft, wherein the first balance weight is provided on the flywheel.

11. The drive unit as claimed in claim 9, further comprising a traction mechanism drive which comprises a wheel driven by the crankshaft and rotating in the opposite direction to the crankshaft, wherein the second balance weight is provided on the wheel driven by the crankshaft rotating in the opposite direction to the crankshaft.

12. The drive unit as claimed in claim 9, further comprising a wheel which is arranged on the crankshaft and drives an assembly via a traction mechanism, wherein the traction mechanism also serves to drive a second wheel rotating in the opposite direction to the crankshaft and the second balance weight is provided on the second wheel and rotates in the opposite direction to the crankshaft.

13. The drive unit as claimed in claim 9, wherein the traction mechanism drives a wheel arranged on the outside of the traction mechanism and the second balance weight is provided on the wheel arranged outside of the traction mechanism, and rotates in the opposite direction to the crankshaft.

14. The drive unit as claimed in claim 9, further comprising a gear wheel which is arranged on the crankshaft and is in engagement with a second gear wheel, wherein the second balance weight is provided on the second gear wheel and rotates in the opposite direction to the crankshaft.

15. The drive unit as claimed in claim 9, wherein the internal combustion engine comprises three cylinders arranged in line.

16. The drive unit as claimed in claim 9, wherein the drive unit is used in a vehicle, wherein the two balance weights are dimensioned and arranged such that the resulting balancing mass force is a mass force oscillating in a vehicle longitudinal direction.

17. A system for an engine comprising:
a cylinder of the engine;
a piston within the cylinder;
a crankshaft rotating responsive to movement of the piston;
a first balance weight;
a second balance weight; and
the first balance weight and the second balance weight rotating around the crankshaft to counter balance vibrations of the crankshaft caused by movement of the piston.

18. The system of claim 17, wherein the first balance weight rotates in a same direction as a rotation of the crankshaft and the second balance weight rotates in an opposite direction as the rotation of the crankshaft.

19. The system of claim 17, further comprising a fly wheel arranged on the crankshaft, wherein the first balance weight is arranged on the flywheel.

20. The system of claim 17, further comprising a traction mechanism drive arranged on the crankshaft, wherein the second balance weight is arranged on the fraction mechanism drive.
